(19) United States
(12) Patent Application Publication
(10) Pub. No.: US 2016/0220970 A1
(43) Pub. Date: Aug. 4, 2016

(54) Method and Apparatus for Rapid Carbonation of a Fluid

(71) Applicants: Robert James, Chichester (GB); Tony Xiao, Shenzhen (CN); Chun-Yen Wang, El Paso, TX (US)

(72) Inventors: Robert James, Chichester (GB); Tony Xiao, Shenzhen (CN); Chun-Yen Wang, El Paso, TX (US)

(73) Assignee: La Vit Technology LLC, New York, NY (US)

(21) Appl. No.: 14/609,713

(22) Filed: Jan. 30, 2015

(51) Int. Cl. B01F 3/04; B01F 15/02; A47J 31/44; A23L 2/54

(52) U.S. Cl. CPC B01F 3/04808; A23L 2/54; B01F 3/04056; B01F 15/0243; A47J 31/44; B01F 2215/008

(57) ABSTRACT

A system and method for rapid carbonization of a fluid such as water. CO2 gas to be pumped into a vessel at an increased pressure greater than one atmosphere. Liquid is then injected into the vessel using the technique of atomization. Atomization is a process where the liquid is caused to take the form of a very large number of tiny droplets. This is done by giving the liquid angular momentum as it is sprayed out of one or more nozzles. The very large number of very small droplets have a tremendously increased surface area increased surface area of the gas-liquid boundary causes very rapid dissolving of the gas in the liquid. The required angular momentum is imparted to the liquid by a curved feed system and by specially shaped nozzles.

### BACKGROUND

1. Field of the Invention

The present invention relates generally to carbonation of a liquid such as water with carbon dioxide gas (CO₂), and more particularly to a method and apparatus for rapid carbonation.

2. Description of the Prior Art

It is well known in the art to carbonate fluids to produce beverages, especially water. For example, Fessler et al. in U.S. Pat. No. 4,187,262 describe a carbonator and liquid level control. McMillin, in U.S. Pat. No. 4,708,827 describes a method and apparatus for dispensing carbonated water with a particular type of pump. Burrows, in U.S. Pat. No. 5,073,312 describes a water carbonation system. Goulet et al. in U.S. Pat. No. 5,156,871 describe a low cost beverage carbonator. Goulet in U.S. Pat. No. 5,419,461 describes a narrow profile, substantially flat carbonator. Vogel et al. in U.S. Pat. No. 5,792,391 describe a basic carbonator as a tube cylinder having a closed and open end. The cylinder has a top that allows water and carbon dioxide gas entry. Improvements continue to be made in carbonation systems such as Novak et al. in U.S. Published Patent Application no. 2013/0129870 which describes dissolving gas in a pre-cursor liquid.

Most prior art carbonation systems simply pump CO2 under pressure into a tank containing water. Some of the systems have ways of mixing the gas into the water such as the Burrows patent which uses impellers and nozzles, or the Goulet et al. '871 patent that uses an electric motor to rock the tank. With the remaining gas in the tank under pressure in most prior art systems, carbonated water can simply be removed by pressure through an exit tube in the bottom of the tank. Many systems use a pump to either pump water or gas into the tank. Most beverage carbonators also have refrigeration or chiller units to reduce the temperature of the carbonated output water for cold beverages. These units also counter the rise in temperature caused by increasing the gas pressure in the tank. Prior art systems typically dissolve from 2.0 to 4.0 volumes of CO2 gas in 1.0 volume of liquid. When the fluid is water, in equilibrium, at 40 degrees F., a gauge pressure of one atmosphere (one atmosphere over ambient or around 14.5 pounds per sq. inch) yields approximately 3.0 volumes of gas to one volume of water. Colder water can hold more dissolved gas at a particular pressure than warmer water. For example, at the same pressure, 35 degree F. water can hold approximately 3.25 volumes. Therefore, an additional advantage to chilling is more dissolved gas.

What the prior art systems fail to provide is rapid carbonization. Carbonated water, or other fluid, is simply carbon dioxide dissolved in the fluid. It is well-known that the rate that CO2 gas dissolves in water is 1) the amount of CO2 gas already dissolved (the process slows as the system approaches saturation), 2) the temperature, 3) the pressure, and 4) the size of the surface area boundary between the gas and the fluid.

Various prior art systems attempt to manipulate some of these parameters such as increasing the surface area of the boundary by mixing or agitating. However, while this technique offers some rate speed-up, the total surface area is only marginally increased. It would be very advantageous to have a system and method for carbonation that took advantage of a tremendously increased fluid surface boundary area to effectuate rapid absorption of the gas into the fluid.

### SUMMARY OF THE INVENTION

The present invention relates to a system and method for rapid carbonization of a fluid such as water. The invention causes CO2 gas to be pumped or otherwise put into a vessel at an increased pressure greater than one atmosphere. Liquid is then injected into the vessel using the technique of atomization. Atomization is a process where the liquid is caused to take the form of a very large number of tiny droplets. This is done by giving the liquid angular momentum as it is sprayed out of one or more nozzles. The very large number of very small droplets have a tremendously increased surface area increased surface area of the gas-liquid boundary causes very rapid dissolving of the gas in the liquid. The required angular momentum is imparted to the liquid by a curved feed system and by specially shaped nozzles.

The present invention sprays atomized water or other fluid into the vessel containing CO2 gas under pressure until the total pressure has increased to a predetermined amount, and the vessel contains a predetermined amount of standing liquid. Since the gas dissolves in the liquid before it comes to rest in the bottom of the vessel, the carbonated liquid may begin to be almost immediately drawn off if needed. A level sensor determines when more gas and/or liquid is needed in the vessel to maintain a steady state.

### DESCRIPTION OF THE FIGURES

Attention is now directed at several drawings that illustrate features of the present invention:

FIG. 1 shows a top perspective view of an embodiment of the carbonation system of the present invention.

FIG. 2 shows a bottom perspective view of the embodiment of FIG. 1.

FIG. 3 shows a perspective view looking up at the removed top of the unit.

FIG. 4 shows a bottom-up view of the feed member of FIG. 4 showing the shower head nozzle assembly

FIG. 5. shows a top-down view of a screw-in liquid feed member showing the feed channels behind the nozzles.

FIG. 6 is a sectioned view of the top of the unit showing the liquid path into the liquid feed member of FIGS. 4-5.

FIG. 7 shows a section view of a nozzle.

Several drawings and illustrations have been presented to aid in understanding the present invention. The scope of the present invention is not limited to what is shown in the figures.

### DESCRIPTION OF THE PREFERRED EMBODIMENT

The present invention relates to spaying atomized liquid droplets into a vessel containing CO₂ gas under pressure. The increased surface area of the droplets leads to rapid absorption of the gas into the liquid. Embodiments of the invention include a pressure vessel with a top having a specialized liquid flow member and nozzle(s) to provide the atomized droplets.

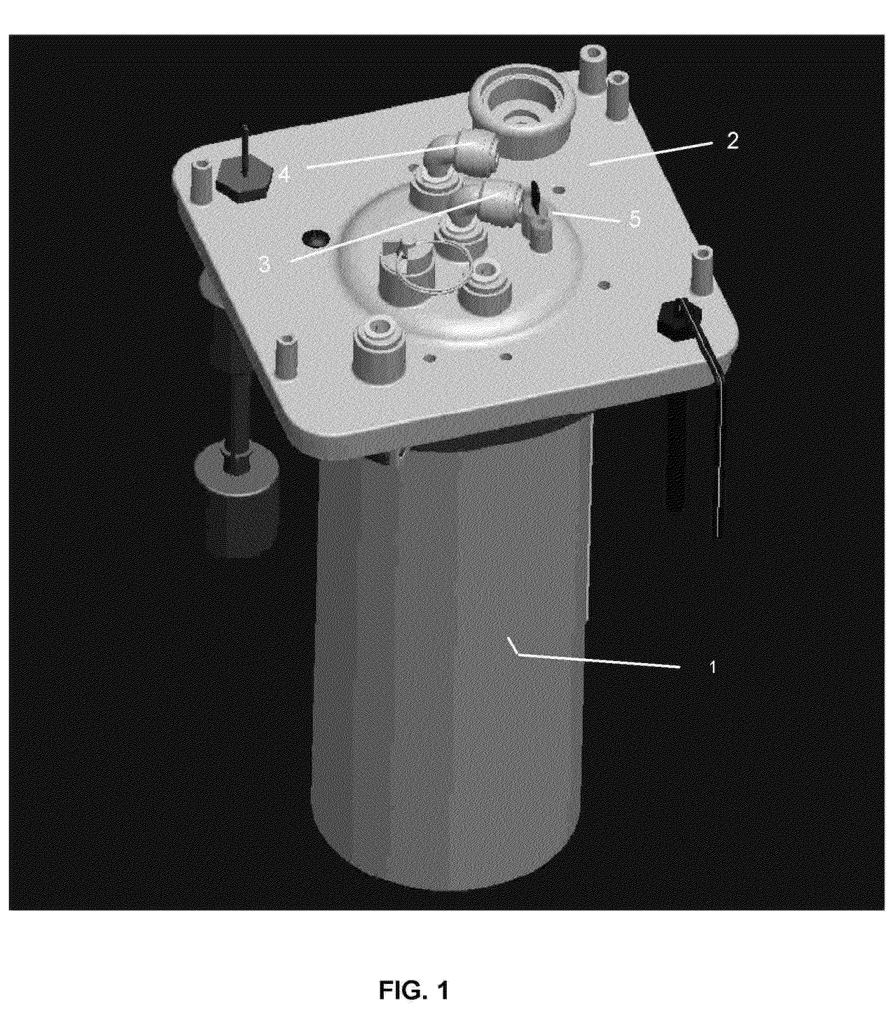

Turning to FIG. 1, an embodiment of the present invention can be seen that includes a cylindrical pressure tank or vessel 1, fitted to a top plate 2 that is equipped with a gas entry port 4 and a liquid entry port 3. A liquid level sensor insert 5 allows continuous measurement of the static liquid level in the vessel 1.

As an example, the vessel 1 is filled with CO₂ gas to a pressure of roughly 3 bar (3 atmospheres, or 43.5 psi gauge). This approximate gas pressure (or any desired working pressure) can be maintained by a pressure regulator on the CO₂ gas supply system. Water can then be pumped in through the atomizer. This water absorbs gas as it enters the vessel. The resulting carbonated water collects in the bottom of the vessel. As the water is sprayed in, the pressure in the vessel would increase if there were no CO₂ gas absorption. If for example, the vessel holds 1000 mL, and assuming a 3 bar gas pressure starting pressure, after around 500 mL of water has been introduced, the pressure would be around 6 bar if gas absorption is neglected (according to the state equation for the gas, the gas temperature will also rise). In a practical situation, the water rapidly absorbs the gas, and the pressure remains approximately constant. If the water spray is stopped when the vessel contains 500 mL of liquid, the pressure will be around 3 bar or less. As previously stated, this pressure can be maintained using a CO₂ gas regulator. It is preferred to regulate the gas pressure because If the gas pressure is allowed to rise excessively, the water pump might see too high a pressure to pump against.

Starting from approximately the second cup of carbonation draw (710 mL), the carbonated water quality is sufficient if the fill time is around 20-30 seconds based on the known absorption rate for systems with an agitator. However, the rapid absorption of the present invention allows a much shorter fill time. It has been determined that, given a design vessel volume of 1000 mL with a fill to 600 mL it is possible to produce two to three 12 ounce (355 mL) good quality carbonated water draws back-to-back if the vessel is filled at a rate sufficient to keep up with the demand. Good quality means around 4.3 volumes of CO₂ for each volume of water.

The above examples are given to aid in understanding the invention. They are for example only. Any size vessel is within the scope of the present invention with corresponding pressures and volumes scaled accordingly. Also, many different equilibrium liquid levels will work and are within the scope of the present invention.

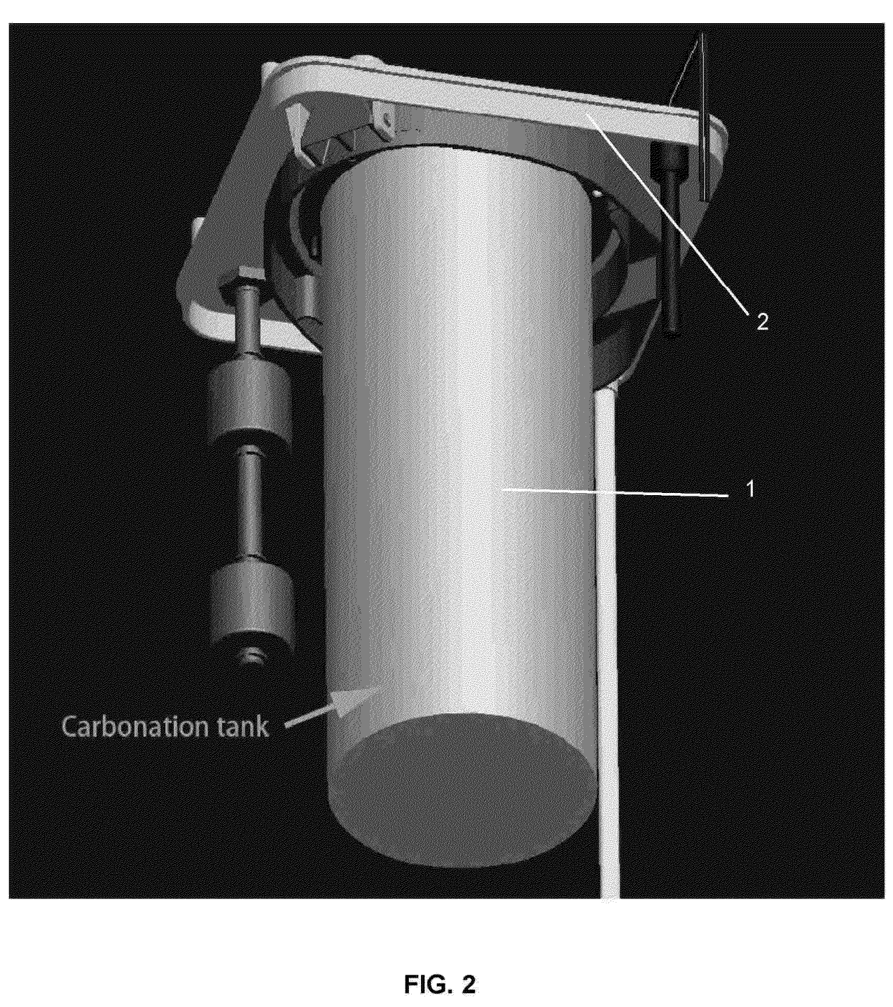

FIG. 2 shows a bottom-up perspective view of the embodiment of FIG. 1. The vessel 1 and the top 2 can be seen.

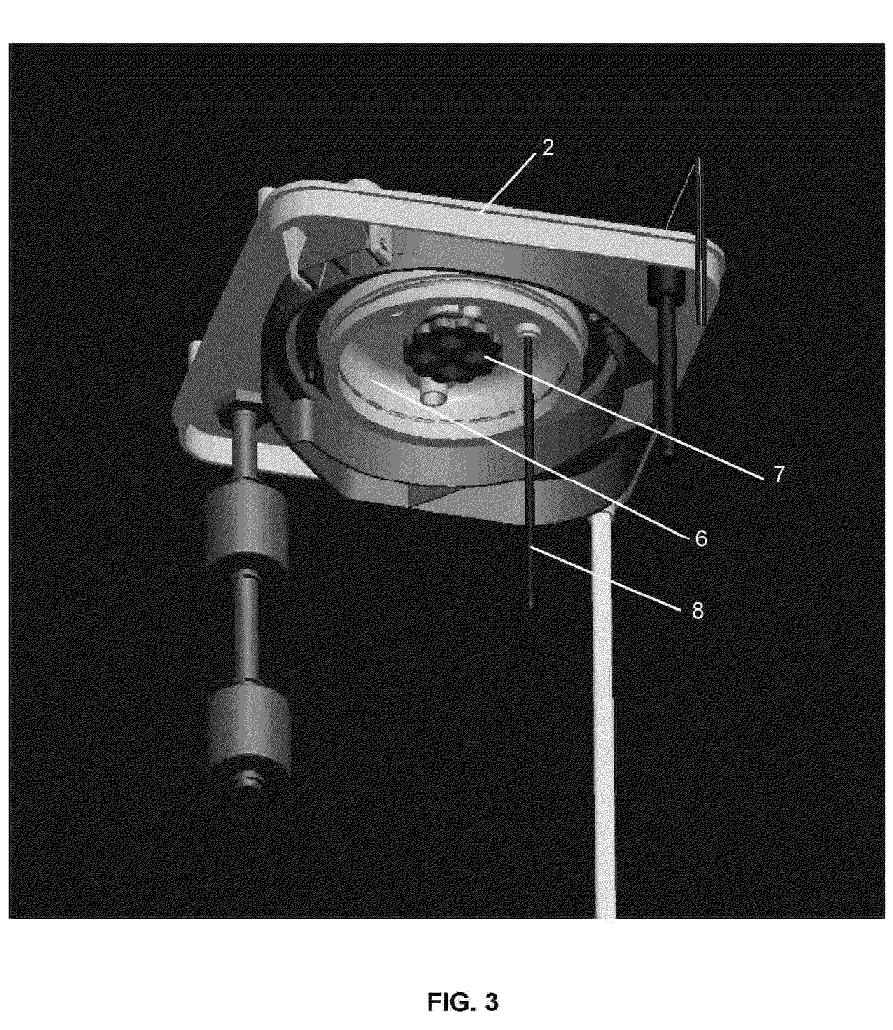

FIG. 3 shows a bottom-up perspective view of the top cap 2 that is pressure-sealed to the vessel in use. The spray nozzle head 7 is attached to a feed member 6 that can screw into the top cap 2. The liquid height sensor 8 is attached to the cap 2 and extends into the vessel.

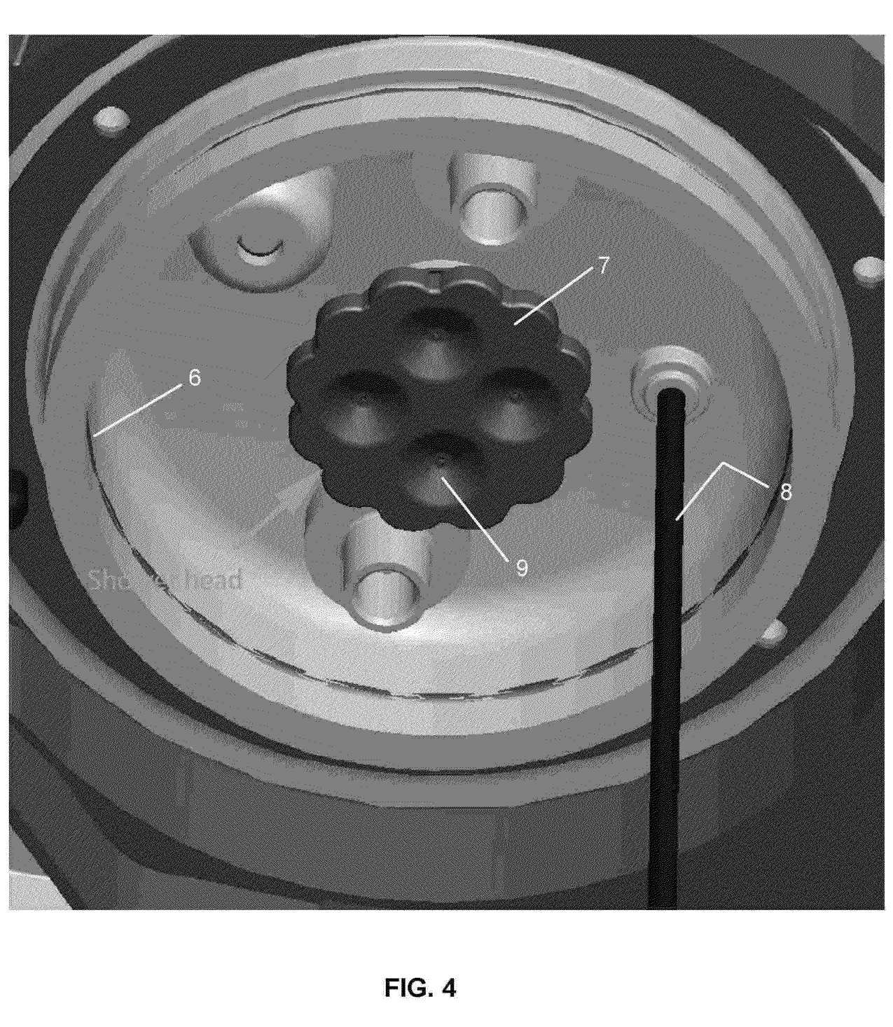

FIG. 4 shows a bottom-up detail view of the screw-in feed member 6. The spray nozzle head 7 in this embodiment includes four individual nozzles 9. The number of nozzles can vary from one to any number. Water, or other liquid, exits the nozzle(s) 9 in the form of tiny atomized droplets traveling at high velocity.

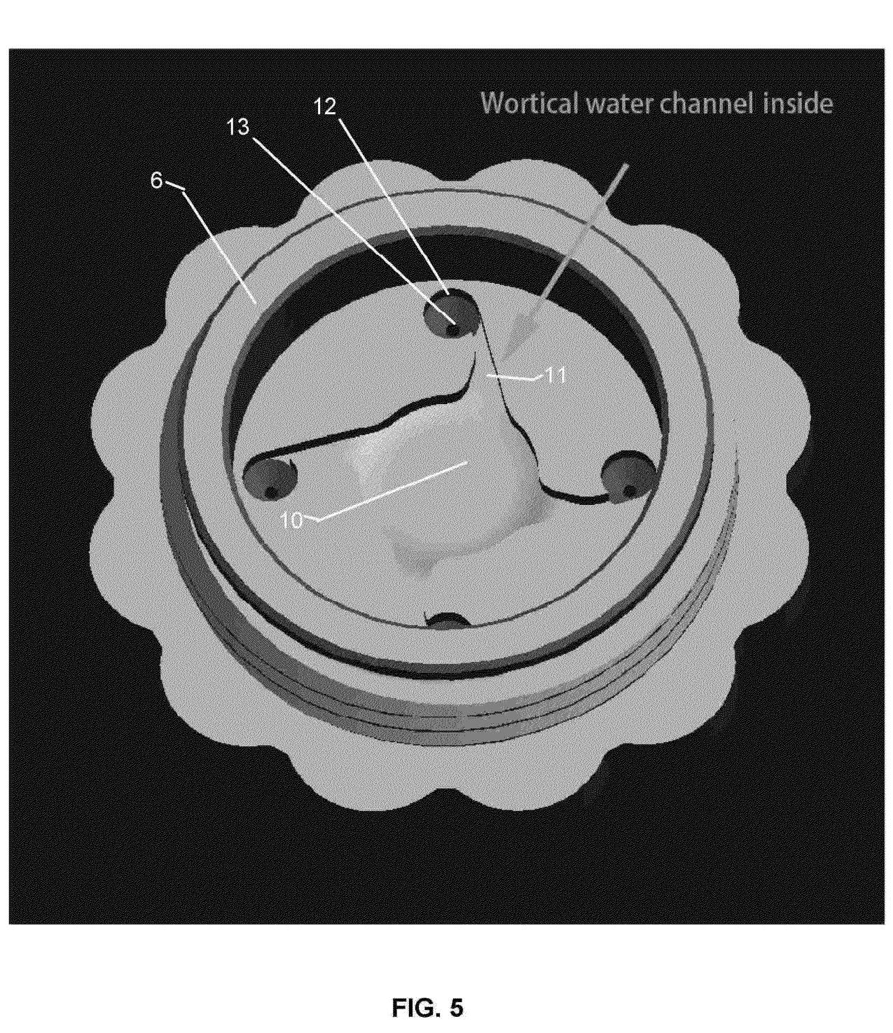

FIG. 5 shows a top-down view of the screw-in feed member 6. Liquid is forced from above this member into the central collector cavity 10. From there, a high velocity stream follows each of the flow channels 11 reaching the top well 12 of each nozzle. The shape of the flow channels 11 and top wells 12 force the liquid stream to acquire angular velocity. The liquid stream circulates around the top well 12 and makes several revolutions before being forced into the nozzle cavity 13. The spinning stream is then forced down into and out of the nozzle. This system using angular velocity causes the liquid to atomize into numerous tiny droplets as it exits the nozzle.

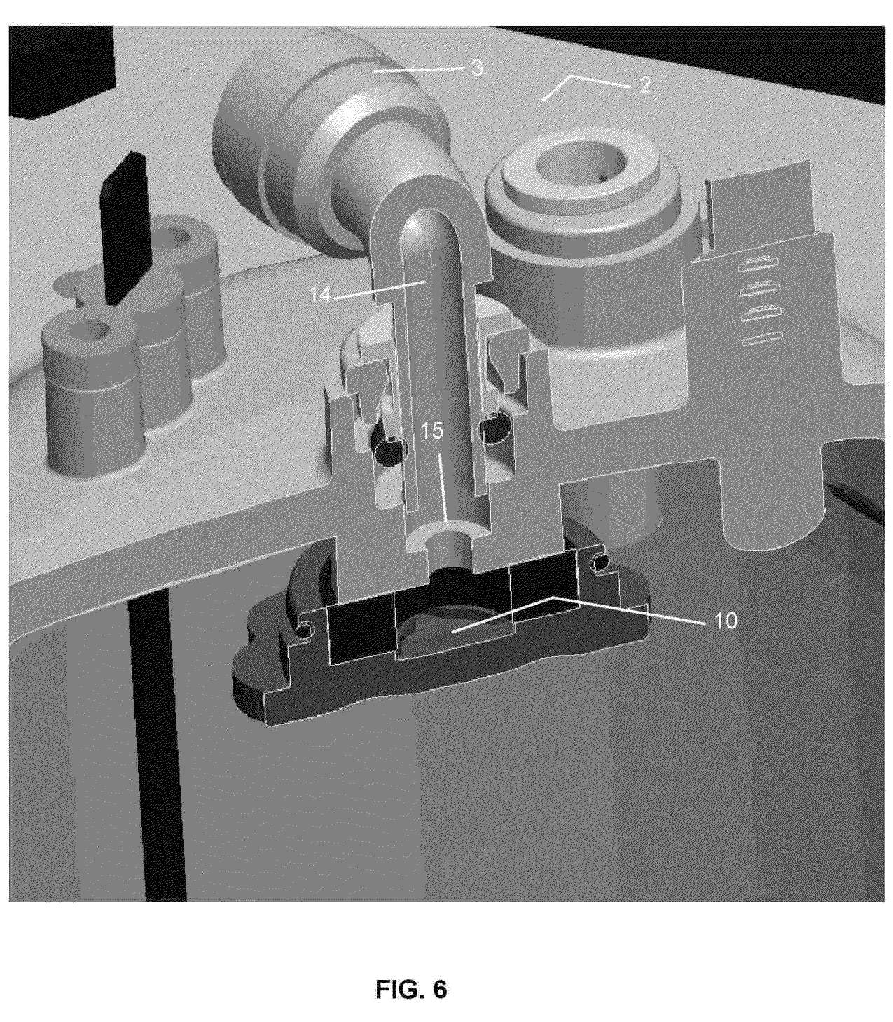

FIG. 6 shows a sectional view of the liquid feed arrangement. Piping from a liquid pump is attached to the external connector or inlet port 3. Liquid flows vertically down a main channel 14 (or first portion of an inlet segment) to a constriction 15 that causes a strong jet of liquid to enter the internal central collector cavity 10. The liquid then acquires angular momentum and is forced down into the nozzles or discharge ports (which is the second portion of the inlet segment).

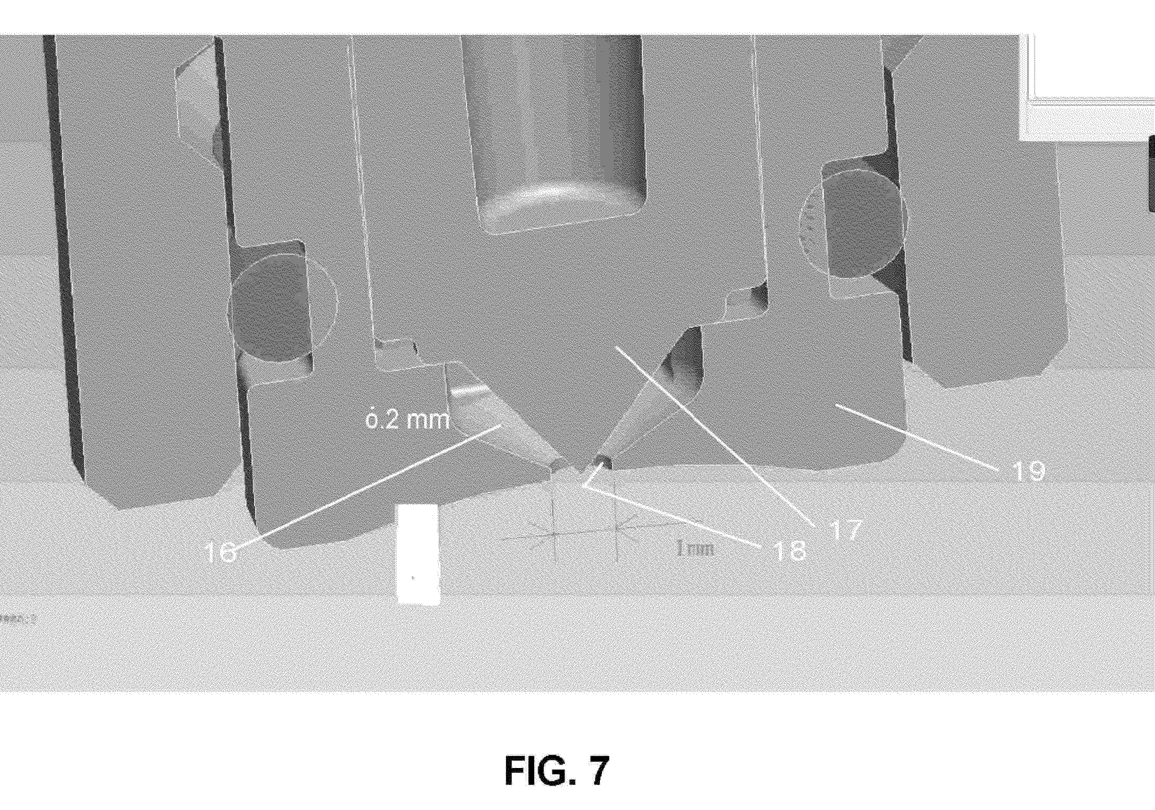

FIG. 7 shows a sectional view of a nozzle. A flow channel 16 causes liquid to pass along a spray member 17 and out through a round exit orifice 18. The preferred dimensions of the exit orifice are approximately 1 mm in diameter and 0.2 mm in depth as shown in FIG. 7. While these dimensions are preferred, many other dimensions will work and are within the scope of the present invention. The pointed spray member 17 extends into the orifice to where its tip is flush with the bottom of the orifice 18. The structure 19 surrounding the orifice 18 is slightly indented to meet the orifice. While FIG. 7 shows an example of a nozzle, many other types of nozzles of different dimensions can be used to atomize the liquid flow.

The present invention provides a rapid way of providing almost continuous carbonation of water or other liquid by atomizing the liquid as it is sprayed into a container containing compressed carbon dioxide gas. This provides an commercial and economic benefit in the dispensing of cold, carbonated beverages. Any technique for atomizing the liquid is within the scope of the present invention.

Several descriptions and illustrations have been provided to aid in understanding the present invention. One with skill in the art will realize that numerous changes and variations may be made without departing from the spirit of the invention. Each of these changes and variations is within the scope of the present invention.

We claim:

1. A method for making a carbonated liquid, including: pumping CO₂ gas into a vessel until pressure of the CO₂ gas in the vessel is greater than one atmosphere;
pumping a liquid into the vessel; atomizing the liquid as it enters the vessel so that the atomized liquid absorbs a portion of the CO₂ gas.

2. The method of claim 1, wherein pressure of the CO₂ gas in the vessel reaches at least three atmospheres.

3. The method of claim 1, wherein the vessel has an inside and outside and includes an inlet segment adapted to allow liquid communication between the inside and outside of the vessel, the inlet segment also adapted to atomize the liquid as it enters the vessel.

4. The method of claim 1 wherein the liquid is water.

5. A method for making a carbonated liquid using an apparatus with a housing that defines a cavity and that includes an inlet segment, the method comprising:
pumping CO₂ gas into the housing until pressure of the CO₂ gas in the housing is greater than one atmosphere;
pumping a liquid into the housing;
atomizing the liquid as it enters the housing so that the atomized liquid absorbs CO₂ gas.

6. The method of claim 5 wherein pressure of the CO₂ gas in the housing reaches at least three atmospheres.

7. The method of claim 5 wherein the housing includes an inlet segment adapted to allow liquid communication between the inside and outside of the housing, the inlet segment also adapted to atomize the liquid as it enters the housing.

8. The method of claim 5, wherein the liquid is water.

9. An apparatus for making a carbonated liquid, the apparatus comprising:
a housing defining an inner space and adapted to receive and contain CO₂ gas under a pressure greater than one atmosphere;
the housing including a liquid inlet segment, the inlet segment defining at least one inlet opening, the inlet segment and the inlet opening adapted to allow liquid communication between a region outside of the housing and the inner space of the housing, the inlet segment and the inlet opening further adapted to atomize the liquid as it enters the inner space of the housing.

10. The apparatus of claim 9, wherein the inlet opening includes: an inlet port adapted to receive the liquid from the outside of the housing, an internal cavity adapted to collect the liquid, at least one discharge port adapted to discharge the liquid into the space, and at least on inner passageway connecting the internal cavity with the discharge port.

11. The apparatus of claim 10, further comprising a plurality of discharge ports and a plurality of inner passageways.

12. The apparatus of claim 11 further comprising four discharge ports and four inner passageways.

13. The apparatus of claim 10, wherein the portion of the inlet segment circumjacent the discharge port has a conical slope.

14. The apparatus of claim 13, wherein the portion of the inlet segment circumjacent the discharge port at the end that communicates with the space and at the end the communicates with the inner passageway has a conical shape.

15. The apparatus of claim 10, wherein the inner passageway curves from the internal cavity to the discharge port.

16. The apparatus of claim 9, wherein the housing defines a CO₂ inlet through which CO₂ gas enters the space in the housing.

17. The apparatus of claim 16 wherein the housing defines a carbonated liquid outlet through which carbonated liquid discharges from the housing.

18. The apparatus of claim 9, further comprising a liquid sensor adapted to indicate the level of the liquid in the space of the housing.

19. The apparatus of claim 9, wherein the housing includes a round barrel-like main segment and a cap-like inlet segment releasably connected to the main segment.

20. The apparatus of claim 19, wherein the main segment is elongate and defines an end opening at one end, the inlet segment normally closing the end opening.

21. An apparatus for cabonating water comprising a tank that includes a first inlet port configured to allow carbon dioxide gas to be pumped into the tank to a pressure greater than one atmosphere; a second inlet port configured to supply pumped water to at least one nozzle located in the tank via a stream feed path configured to impart angular momentum to the stream before reaching the nozzle which causes the water to atomize into small droplets upon exiting the nozzle, wherein, the small droplets absorb carbon dioxide.

22. The apparatus of claim 20 further comprising an outlet port on the tank adapted to withdraw carbonated water from the tank.
